(19) United States
(12) Patent Application Publication
(10) Pub. No.: US 2026/0329459 A1
(43) Pub. Date: Oct. 22, 2026

(54) HANDLING MEMORY DIE WITH UNEVEN PEC CAPABILITY IN MEMORY SYSTEM

(71) Applicant: Micron Technology, Inc., Boise, ID (US)

(72) Inventors: Guang Shen, Shanghai (CN); Meng Wei, Shanghai (CN); Donghua Zhou, Shanghai (CN)

(21) Appl. No.: 19/186,075

(22) Filed: Apr. 22, 2025

(51) Int. Cl. G06F 3/06

(52) U.S. Cl. CPC G06F 3/0629; G06F 3/0619; G06F 3/0673

(57) ABSTRACT

Various example embodiments provide for handling memory device die with uneven program/error count (PEC) capability in a memory system, such as a memory sub-system. In particular, various example embodiments cause a memory system to use one or more weak NAND-type memory device die of a memory device (of the memory system) in a lower bit-per-cell mode or configuration (e.g., SLC mode) than the higher bit-per-cell mode or configuration (e.g., MLC mode, TLC mode or QLC mode) used with one or more non-weak NAND-type memory device die of the memory device, thereby enabling the use of the one or more weak NAND-type memory device die to match the PEC capability of the one or more non-weak NAND-type memory device die.

### TECHNICAL FIELD

Example embodiments of the disclosure relate generally to memory devices and, more specifically, to handle memory device die with uneven program/erase count (PEC) capability in a memory system, such as a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various example embodiments of the disclosure. The drawings, however, should not be taken to limit the disclosure to the specific example embodiments, but are for explanation and understanding only.

FIG. 1 is a block diagram illustrating an example computing system that includes a memory sub-system, in accordance with some example embodiments of the present disclosure.

FIG. 2 is a flow diagram of an example method for handling memory device die with uneven PEC capability in a memory system, in accordance with some example embodiments of the present disclosure.

FIG. 3 is a diagram illustrating an example of how redundant array of independent NAND-type memory devices (RAIN) protection is handled with respect to memory device die having uneven PEC capability in a memory system, in accordance with some example embodiments of the present disclosure.

FIG. 4 is a diagram illustrating an example of how physical memory address-to-logical memory address (P2L) data is handled with respect to memory device die having uneven PEC capability in a memory system, in accordance with some example embodiments of the present disclosure.

FIG. 5 is a block diagram of an example computer system in which example embodiments of the present disclosure may operate.

### DETAILED DESCRIPTION

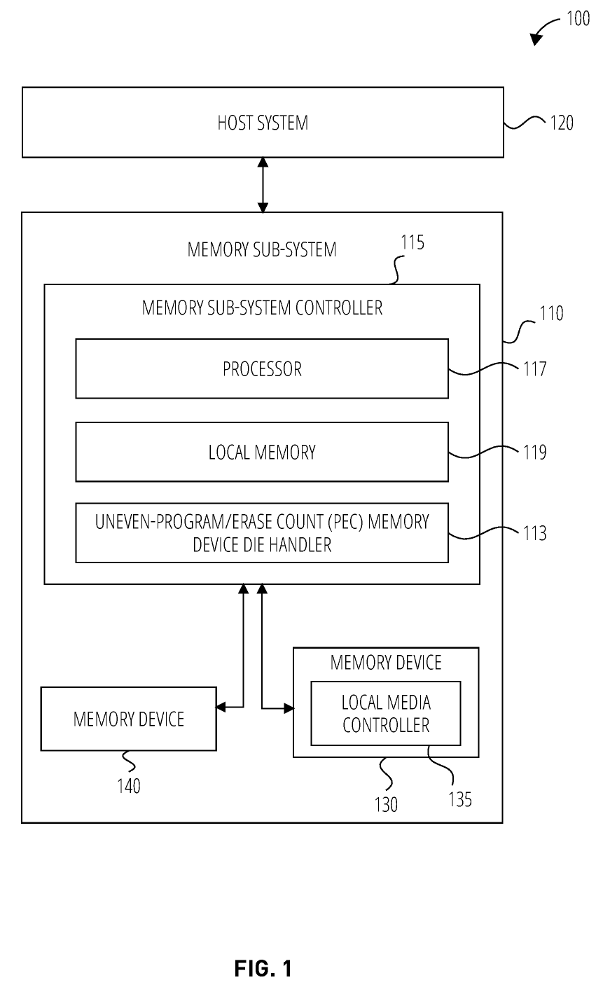

Aspects of the present disclosure are directed to handling memory die with uneven PEC capability in a memory system, such as a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

As used herein, a logical memory address can comprise a logical block address (LBA), which can be provided by a host system to a memory device or a memory sub-system. For example, depending on a physical interface used between a host system and a memory device/memory sub-system, an LBA can comprise a 2-byte or 4-byte number. As used herein, a physical memory address can comprise a memory address on a memory device or a memory sub-system where data (e.g., user data) is stored. For example, the physical memory address can comprise a physical block address (PBA), which can be a position within an underling non-volatile memory device that can be identified by a 4-byte number or a tuple of numbers (e.g. die ID, block ID, page ID). As used herein, address mapping data can comprise a logical memory address-to-physical memory address (L2P) data (e.g., L2P mapping or translation table), which can associate (and therefore facilitate translation or reconstruction of) a physical memory address to a logical memory address (or vice versa) of a memory device or a memory sub-system. Additionally, physical memory address-to-logical memory address (P2L) data can be saved on a memory sub-system as backup data that can be used to rebuild a L2P mapping/L2P data (e.g., if L2P data is lost or becomes unavailable in local memory of the memory system controller).

Conventional memory sub-systems can employ error-correction techniques, such as using a redundant array of independent NAND-type memory devices (RAIN) technique, to protect data (e.g., host or user data) stored on the memory sub-systems. Error-correction techniques can comprise calculating parity (e.g., exclusive OR (XOR) parity) across some collection of data (e.g., host/user data) being error-protected. By such error-correction techniques, if a data member of the collection is lost (e.g., corrupted) for any reason, the parity calculation can be re-performed and the lost data recreated. As error-correction techniques, such as RAIN techniques, get more complex, so can the number of parallel parity calculations performed to achieve the error-correction protection, and the memory resources needed to perform the parallel parity calculations. For example, when the set of memory components comprises multi-plane NAND-type memory devices, such as triple-level cell (TLC) NAND-type memory devices, multiple (e.g., dozens of) parity calculations may need to be performed in parallel to implement data protection (e.g., for host/user data) stored on the memory sub-system. Data in such conventional memory sub-systems is usually written sequentially across multiple memory device die (e.g., NAND-type memory device die) of one or more NAND-type memory devices. When the data is completely written across a given row of blocks of a specified set of memory device die of the one or more NAND-type memory devices, the RAIN parity calculation is performed and stored in a parity block associated with the given row (e.g., wordline). Depending on the implementation, a memory device can implement plane-level RAIN protection or a memory device die-level RAIN protection (also referred to herein as die-level RAIN protection).

The memory sub-system can initiate media management operations, such as a write operation, on host data that is stored on a memory device. For example, firmware of the memory sub-system may re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., physical memory address-to-logical memory address mapping table (also referred to herein as a P2L table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package.

Generally, writing data to NAND-type memory devices involves programming (by way of a program operation) the NAND-type memory devices at the page level of a block, and erasing data from such memory devices involves erasing the memory devices at the block level (e.g., page level erasure of data is not possible). Certain memory devices, such as NAND-type memory devices, comprise one or more blocks, (e.g., multiple blocks) with each of those blocks comprising multiple pages, where each page comprises a subset of memory cells of the block, and where a single wordline of a block (which connects a group of memory cells of the block together) defines one or more pages of a block (depending on the type of memory cell). Depending on the embodiment, different blocks can comprise different types of memory cells. For instance, a block (a single-level cell (SLC) block) can comprise multiple SLCs, a block (a multi-level cell (MLC) block) can comprise multiple MLCs, a block (a triple-level cell (TLC) block) can comprise multiple TLCs, a block (a quad-level cell (QLC) block) can comprise QLCs, and a block (a penta-level cell (PLC) block) can comprise PLCs. Other blocks comprising other types of memory cells (e.g., higher-level memory cells, having higher bit storage-per-cell) are also possible.

Each wordline (of a block) can define one or more pages depending on the type of memory cells (of the block) connected to the wordline. For example, for an SLC block, a single wordline can define a single page. For an MLC block, a single wordline can define two pages – a lower page (LP) and an upper page (UP). For a TLC block, a single wordline can define three pages – a lower page (LP), an upper page (UP), and an extra page (XP). For a QLC block, a single wordline can define four pages – a lower page (LP), an upper page (UP), an extra page (XP), and a top page (TP) page. As used herein, a page of LP page type can be referred to as a “LP page,” a page of UP page type can be referred to as a “UP page,” a page of XP page type can be referred to as a “XP page,” and a page of TP page type can be referred to as a “TP page.” Each page type can represent a different level of a cell (e.g., QLC can have a first level for LPs, a second level for UPs, a third level for XPs, and a fourth level for TPs). To write data to a given page, a wordline associated with the given page is programmed according to a page programming algorithm (e.g., that causes one or more voltage pulses or pulses to memory cells of a block based on the memory). Generally, programming a single wordline of a block results all the pages in the single wordline being programmed, where the number pages being programmed depends on the type of block. For example, programming a single wordline of a QLC block usually results in four pages (e.g., LP, UP, XP, TP pages) associated with the single wordline being programmed.

Memory sub-systems, such as solid state drives (SSDs), can be constructed using one or more memory packages (e.g., NAND-type memory packages), with each memory package comprising one or more individual memory device die (e.g., NAND-type memory device die). Hereafter, a NAND-type memory package can refer to a memory package comprising one or more NAND-type memory device die (hereafter, NAND memory die), and a NAND memory die can refer to a NAND-type memory device die. During the manufacturing process of a memory die, variation in memory die quality is an inherent challenge of the manufacturing process. The quality of an individual memory die is typically characterized by its Program/Erase Count (PEC) capability, which can represent the number of times a memory cell of the memory die can be reliably programmed and erased during its lifetime.

A typical NAND memory die that comprises TLCs is typically expected to sustain approximately 10,000 program/erase cycles (e.g., a PEC of 10,000). However, manufacturing variations can result in some NAND memory die having significantly reduced PEC capabilities, sometimes as low as 3,000 program/erase cycles. A memory die having significantly reduced PEC capabilities (e.g., reduced in comparison to an expected or desired level of PEC capabilities) can be referred to as a weak memory die or a low-PEC memory die. This variation can present a significant challenge in NAND-type memory package qualification, as a single underperforming NAND memory die in a multi-die NAND-type memory package can lead to the entire memory package being deemed unsuitable for use. For instance, if a NAND-type memory package comprising 16 NAND memory die had only one weak memory die, the NAND-type memory package could be deemed unsuitable for use.

To address this, there are existing approaches to manage NAND memory die (e.g., in a multi-die NAND-type memory package) with uneven PEC capabilities, which typically involve using weak memory die of the NAND-type memory package less frequently than non-weak memory die (e.g., stronger memory die) of the NAND-type memory package, often in a ratio corresponding to the relative endurance capabilities of individual NAND memory die. These existing approaches include such techniques as selective usage patterns of weak memory die versus non-weak memory die, and wear-leveling algorithms. For example, for a NAND-type memory package that comprises 15 NAND memory die having the capability to sustain 10,000 PEC and one weak NAND memory die having the capability to sustain 3,000 PEC, a memory sub-system can cause the NAND-type memory package to use the weak NAND memory die less than others, such as: use the weak NAND memory die once for every time the non-weak NAND memory die is used three times (e.g., to keep a roughly 1:3 ratio); or use the weak NAND memory die only for certain use cases, such as use the NAND memory die only for host writes, while non-weak NAND memory die can be used for host writes and garbage collection writes. Overall, existing approaches for managing NAND memory die with uneven PEC capabilities involve using a weak NAND memory die with intervals so that a weak NAND memory die of a NAND-type memory package can match the lifecycle of non-weak NAND memory die in the NAND-type memory package.

Unfortunately, existing approaches to manage NAND memory die with uneven PEC capabilities within a NAND-type memory package result in fluctuations in the physical data size of the NAND-type memory package during runtime when weak NAND memory die is used at certain times and filtered out of use (e.g., is avoided) at other times. Specifically, conventional solutions (for managing NAND memory die with uneven PEC capability) cannot maintain consistent memory sub-system performance by selectively using or filtering out weak NAND memory die, which causes the effective physical size of the memory sub-system to fluctuate during operation. This variability in available storage capacity on the memory sub-system that includes one or more NAND-type memory packages, such as enterprise-level (e.g., datacenter grade) SSDs, can make it challenging to deliver the consistent performance levels desired for enterprise applications. Maintaining consistent and predictable performance is particularly crucial to users expecting stable performance from a memory sub-system throughout the memory sub-system's lifetime.

Various example embodiments described herein provide block failure protection for handling memory die with uneven program/error count (PEC) capability in a memory system, such as a memory sub-system. In particular, various example embodiments cause a memory system to use one or more weak NAND memory die of a memory device (of the memory system) in a lower bit-per-cell mode or configuration (e.g., SLC mode) than the higher bit-per-cell mode or configuration (e.g., MLC mode, TLC mode or QLC mode) used with one or more non-weak NAND memory die of the memory device, thereby enabling the use of the one or more weak NAND memory die to match the PEC capability of the one or more non-weak NAND memory die. By operating a weak NAND memory die (that is otherwise capable of higher bit-per-cell operations but with lower than desirable PEC results) in a lower bit-per-cell mode or configuration, various example embodiments enable the weak NAND memory die to perform not only with higher speed, increased endurance, and more reliability, but also enable the weak NAND memory die top achieve higher PEC capability than it would in a higher bit-per-cell mode or configuration. Accordingly, various example embodiments trade-off storing more bits per cell (in order to maximize the data storage capacity of the weak NAND memory die) for increased performance and longevity. Additionally, use of various example embodiments adjusts the PEC capability of weak NAND memory die of a NAND-type memory device (e.g., a NAND-type memory package) while keeping physical data storage size of the NAND-type memory device. For some example embodiments, using a weak NAND memory die as described herein achieves a higher PEC capability that is on par or commensurate with the PEC capability of a non-weak NAND memory die of the NAND-type memory device, where the non-weak NAND memory die and the weak NAND memory die are otherwise identical. Overall, the adjustment of uneven PEC capability to use weak NAND memory die as described herein can improve the yield rate of NAND memory die, which in turn can improve manufacturing output and save manufacturing cost of NAND memory die and NAND-type memory devices (e.g., NAND-type memory packages).

Depending on the example embodiment, within an individual memory device of a memory system, memory die with lower than expected/desired PEC capability (e.g., approximately 3,000 PEC) can be identified as weak memory die during manufacturing, operation (e.g., normal use by user/customer), or both. For example, where a weak memory die of a memory device is identified during manufacturing, this information can be stored as data on persistent memory of a memory system (that includes the memory device) and can be subsequently used by the memory system to adjust operation of the weak memory die to a lower bit-per-cell mode or configuration. For instance, where the weak NAND memory die can support operation in a MLC, TLC, or QLC mode or configuration, the memory system can be configured to use that weak NAND memory die in SLC mode or configuration. This can for example render a weak NAND memory die, which achieves a PEC of 10,000 cycles operating in a TLC mode/configuration, to achieve a PEC of approximately 80,000 cycles while operating in a SLC mode/configuration, thereby allowing the weak NAND memory die to match or exceed the lifecycle of one or more of the non-weak NAND memory die of the memory device.

With respect to programming, some example embodiments use a translation mechanism that causes pages to be programmed sequentially across one or more page stripes across multiple memory device die, where programming each individual page stripe comprises programming each page type of the individual page stripe on a current memory device die prior to programming each page type of the individual page stripe on a next individual memory device die (e.g., next memory device die based on a logical order of memory device die). For instance, with respect to an individual page stripe that comprises pages across multiple memory device die at an individual wordline, programming those pages on any non-weak memory device die operating in TLC mode by programming all LPs, UPs, and XPs at the individual wordline of the non-weak memory device die (e.g., first all LPs across all memory die planes, then all UPs across all memory die planes, and then all XPs across all memory die planes), and programming those pages on any weak memory device die operating in SLC mode by programming all LP pages (also referred to herein as SLC pages) at the individual wordline of the weak memory device die.

Use of various example embodiments described herein enables memory device die with uneven PEC capability to be handled while providing consistent page stripe sizes in a memory device of a memory system, thereby ensuring stable physical data storage size on the memory system and stable performance of the memory system. Various example embodiments enable consistent performance throughout a memory device's lifecycle while improving manufacturing yield rates (e.g., by enabling use of weak memory device die that would otherwise be considered unsuitable).

According to various example embodiments, a memory system preserves RAIN protection functionality through a specialized XOR-based approach that accounts for use of mixed weak/non-weak memory device die configurations. Where non-weak memory device die operate in TLC mode and weak memory device die operate in SLC mode, the memory system can skip non-existent UP and XP pages on weak memory device die (non-existent because they are operating in SLC mode) when performing XOR operations across the page stripe. Additionally, for some example embodiments, to ensure proper RAIN protection implementation, the memory system logically reorders memory device die so that one or more non-weak memory device die (e.g., TLC-configured non--weak memory device die) are designated for storing RAIN parity data, as weak memory device die (e.g., SLC-configured weak memory device die) cannot store the complete XOR data for a full page stripe. This logical reordering can maintain the physical memory device die arrangement while enabling consistent RAIN protection across the mixed weak/non-weak memory device die configurations.

For managing internal data structures, the memory system of some example embodiments cause P2L data (e.g., comprising one or more P2L mapping tables) to be stored at a location that accommodates use of weak memory device die in lower bit-per-cell mode (e.g., SLC mode) operation while maintaining data (e.g., L2P data) recovery capabilities. When writing data, the memory system can store P2L data (e.g., also referred to as a P2L data drop) at the end of page stripes, with flexibility to position the P2L data either in a last page of weak memory device die or a last page of a non-weak memory device die depending on the memory device die configuration (e.g., logical order of the memory device die with respect to page stripes). As described herein, P2L data (e.g., one or more P2L mapping tables) comprise physical memory address-to-logical memory address translations that enable rebuilding of L2P data (e.g., one or more L2P mapping tables) if the L2P data becomes unavailable, thereby ensuring data integrity across both weak and non-weak memory device die.

As used herein, a weak memory device die (or weak memory die) can refer to a memory die having reduced (e.g., significantly reduced) PEC capabilities in comparison to an expected or desired level PEC capabilities for the memory die (e.g., expected/desired PEC capability based on the memory die's make, model, design, or some combination thereof). A weak memory device die can also be referred to as a low-PEC memory device die (or low-PEC memory die). A non-weak memory device die (or non-low-memory die) can refer to a memory die having PEC capabilities that meet or exceed an expected or desired level PEC capabilities for the memory die (e.g., expected/desired PEC capability based on the memory die's make, model, design, or some combination thereof). Where a given memory device (e.g., memory package) comprises a mix of non-weak and weak memory die, such memory die are usually (but not necessarily) of the same make, model, or design and, thus, expected to have the same PEC capability.

Disclosed herein are some examples of handling memory die with uneven PEC capability in a memory system (e.g., memory sub-system), as described herein.

FIG. 1 illustrates an example computing system 100 that includes a memory sub-system 110, in accordance with some example embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. The computing system 100 can be used to support or implement various types of applications, including those relating to artificial intelligence (AI).

The computing system 100 can include a host system 120 that is coupled to one or more memory sub-systems 110. In some example embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further use an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, SLCs, can store one bit per cell. Other types of memory cells, such as MLCs, TLCs, QLCs, and penta-level cells (PLCs), can store multiple bits per cell. In some example embodiments, each of the memory devices 130, 140 can include one or more arrays of memory cells such as SLCs, MLCs, TLCs, QLCs, or any combination of such. In some example embodiments, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as an MLC block, a block comprising TLCs can be referred to as a TLC block, a block comprising QLCs can be referred to as a QLC block, and a block comprising PLCs can be referred to as a PLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some example embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some example embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some example embodiments, the memory device 130 includes local media controller 135 that operates in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some example embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a uneven-program/erase count (PEC) memory device die handler 113 (hereafter, the uneven-PEC memory device die handler 113) that enables or facilitates the memory sub-system controller 115 to handle memory device die with uneven PEC capability in the memory sub-system 110 in accordance with various example embodiments described herein. Alternatively, some or all of the uneven-PEC memory device die handler 113 is included by the local media controller 135, thereby enabling the local media controller 135 to enable or facilitate handling of memory device die with uneven PEC capability in the memory sub-system 110.

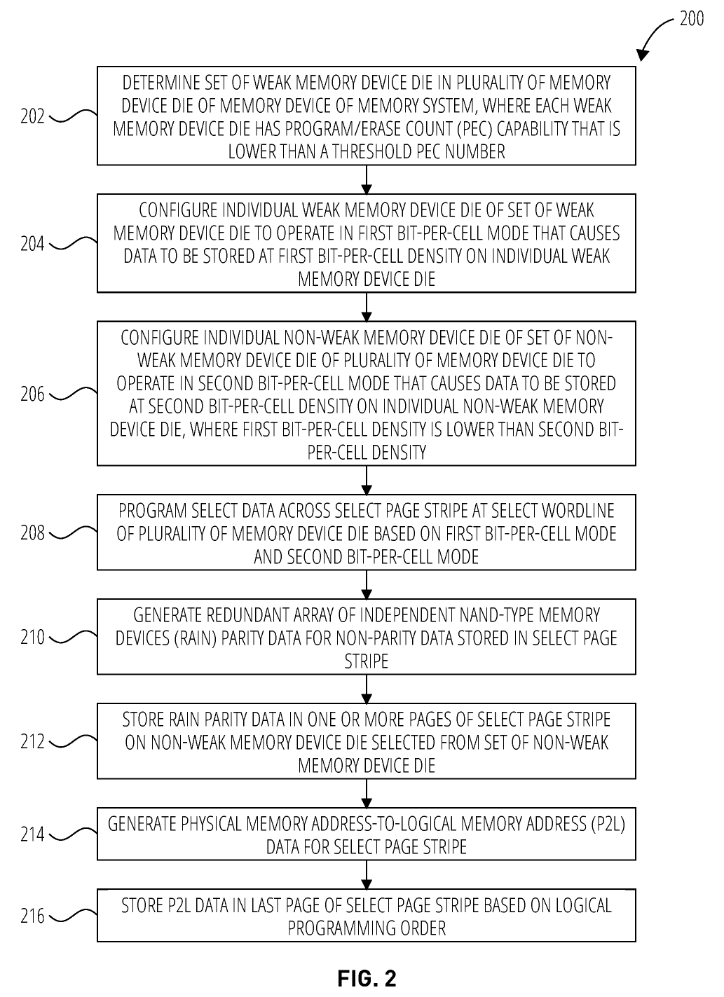

FIG. 2 is a flow diagram of an example method 200 for handling memory device die with uneven PEC capability in a memory system, in accordance with some example embodiments of the present disclosure. Method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some example embodiments, method 200 is performed by the memory sub-system controller 115 of FIG. 1 based on the uneven-PEC memory device die handler 113. Additionally, or alternatively, for some example embodiments, the method 200 is performed, at least in part, by the local media controller 135 of the memory device 130 of FIG. 1. Although shown in a particular sequence or order, unless otherwise specified, the order of the processes can be modified. Thus, the illustrated example embodiments should be understood only as examples, and the illustrated processes can be performed in a different order, and some processes can be performed in parallel. Additionally, one or more processes can be omitted in various example embodiments. Thus, not all processes are used in every example embodiment. Other process flows are possible.

Referring now to method 200 of FIG. 2, at operation 202 a processing device (e.g., the processor 117 of the memory sub-system controller 115) determines a set of weak memory device die in a plurality of memory device die of a memory device (e.g., 130 or 140) of a memory system (e.g., memory sub-system 110). Each memory device die can comprise multiple memory device die planes, with each memory plane comprising multiple memory cells. Each memory device die of the plurality of memory device die can comprise a NAND-type memory device die. Additionally, the memory device can comprise a NAND-type memory package.

For various example embodiments, each weak memory device die of the set of weak memory device die has a PEC capability that is lower than a threshold PEC number. Depending on the example embodiment, the threshold PEC number can be determined (e.g., by the manufacturer) during the manufacture of the memory device or the memory system, or the threshold PEC number can be determined (e.g., by an internal process of the memory system) during operation of the memory system (e.g., operation of the memory system by a customer). The threshold PEC number can be determined based on the PEC capability (e.g., expected or observed PEC) of one or more non-weak memory device die of the plurality of memory device die. For instance, if the PEC capability of a non-weak memory device die is known, determined (e.g., observed or measured), or expected (e.g., based on design) to be 10,000 PEC while operating in TLC mode, the threshold PEC number can be set to a value at or around 10,000.

At operation 204, the processing device configures an individual weak memory device die of the set of weak memory device die to operate in a first bit-per-cell mode that causes data to be stored at a first bit-per-cell density on the individual weak memory device die. For some example embodiments, this can be done for each individual weak memory device die in the set of weak memory device die. Depending on the example embodiment, the configuration of one or more weak memory device die can be saved in configuration or settings data saved on the memory system, where the data can be specifically associated with the memory device or the individual memory device die.

For operation 206, the processing device configures an individual non-weak memory device die of a set of non-weak memory device die of the plurality of memory device die to operate in a second bit-per-cell mode that causes data to be stored at a second bit-per-cell density on the individual non-weak memory device die, where the first bit-per-cell density is lower than the second bit-per-cell density. For some example embodiments, this can be done for each individual non-weak memory device die in the set of non-weak memory device die. Depending on the example embodiment, the second bit-per-cell mode can comprise either MLC mode, TLC mode, or QLC mode, and the first bit-per-cell mode can comprise SLC mode. Where the second bit-per-cell mode comprises MLC mode, the first bit-per-cell mode can comprise SLC mode. Where the second bit-per-cell mode comprises TLC mode, the first bit-per-cell mode can comprise either SLC mode or MLC mode. Where the second bit-per-cell mode comprises QLC mode, the first bit-per-cell mode can comprise either SLC mode, MLC mode, or TLC mode.

During operation 208, the processing device programs select data across a select page stripe at a select wordline of the plurality of memory device die based on the first bit-per-cell mode and the second bit-per-cell mode. According to various example embodiments, operation 208 comprises the processing device programs any pages of the select page stripe on any weak memory device die based on one or more page types associated with the first bit-per-cell mode, and the processing device programs any pages of the select page stripe on any non-weak memory device die based on one or more page types associated with the second bit-per-cell mode. Where the first bit-per-cell mode comprises a SLC mode, the one or more page types associated with the first bit-per-cell mode can comprise a LP at each wordline on each memory device die plane of a memory device die that is configured to operate in the first bit-per-cell mode. Where the second bit-per-cell mode comprises a MLC mode, the one or more page types associated with the second bit-per-cell mode can comprise a LP and a UP at each wordline on each memory device die plane of a memory device die that is configured to operate in the second bit-per-cell mode. Where the second bit-per-cell mode comprises a TLC mode., the one or more page types associated with the second bit-per-cell mode can comprise a LP, a UP, and a XP at each wordline on each memory device die plane of a memory device die that is configured to operate in the second bit-per-cell mode. Where the second bit-per-cell mode comprises a QLC mode., the one or more page types associated with the second bit-per-cell mode can comprise a LP, a UP, a XP, and a TP at each wordline on each memory device die plane of a memory device die that is configured to operate in the second bit-per-cell mode.

According to various example embodiments, the programming of any pages of the select page stripe on an individual memory device die (e.g., weak or non-weak memory device die) based on one or more page types associated with a current bit-per-cell mode of the individual memory device die comprises programming all pages of a first-page type (e.g., LPs) on each memory device die plane (e.g., memory device die planes 0 through 3) of an individual memory device die prior to programming any page of a second-page type (e.g., UPs) on each memory device die plane (e.g., memory device die planes 0 through 3) of the individual memory device die. With respect to the select page stripe, this can continue for each different page type (e.g., XP, TP, etc.) on the individual memory device die, depending on the current bit-per-cell mode or configuration of the individual memory device die, until all page types are programmed. Thereafter, the programming can proceed to programming of one or more pages of the select page stripe on a next memory device die, where the next memory device die is determined based on a logical memory device die order assigned to the plurality of memory device die of the memory device.

For example, where one or more non-weak memory device die of the memory device are each configured to operate in TLC mode, and one or more weak memory device die of the memory device are each configured to operate in SLC mode, programming pages of a current page stripe on an individual non-weak memory device die at a current wordline can comprise programming first all LPs, then all UPs, and then all XPs before programming of pages of the current page stripe on a next memory device die (if there is a next memory device die) as determined by a logical memory device die order. Where the next memory device is another non-weak memory device die, the order of programming of pages would repeat (e.g., LPs, then UPs, then XPs), however where the next memory device is an individual weak memory device die, programming of the current page stripe on the individual weak memory device die at the current wordline can comprise programming all LPs (e.g., SLC pages) before programming of pages of the current page stripe on a next memory device die (if there is a next memory device die) as determined by the logical memory device die order.

For operation 210, the processing device generates RAIN parity data for non-parity data stored in the select page stripe. According to various example embodiments, the memory system (e.g., memory sub-system 110) implements RAIN parity data generation based on the configured bit-per-cell modes of individual memory device die. For example, where each weak memory device die is configured to operate in SLC mode and each non-weak memory device die is configured to operate in MLC mode, the processing device can generate first RAIN parity data by XORing non-parity data across LPs (of the select page stripe) of both weak (SLC-mode) and non-weak (MLC-mode) memory device die, and can generate second RAIN parity data by XORing non-parity data stored across UPs (of the select page stripe) of non-weak (MLC-mode) memory device die, where the first RAIN parity data and the second RAIN parity data are combined (e.g., XOR'd) to generate the RAIN parity data for the select page stripe. In this way, the weak (SLC-mode) memory device die is skipped during generation of the second RAIN data, as the weak memory device die does not include UPs in SLC mode.

Where each weak memory device die is configured to operate in SLC mode and each non-weak memory device die is configured to operate in TLC mode, the processing device can generate first RAIN parity data by XORing non-parity data across LPs (of the select page stripe) of both weak (SLC-mode) and non-weak (TLC-mode) memory device die, can generate second RAIN parity data by XORing non-parity data stored across UPs (of the select page stripe) of non-weak (TLC-mode) memory device die, and can generate third RAIN parity data by XORing non-parity data stored across XPs (of the select page stripe) of non-weak (TLC-mode) memory device die, where the first RAIN parity data, the second RAIN parity data, and the third RAIN parity data are combined (e.g., XOR'd) to generate the RAIN parity data for the select page stripe. In this way, the weak (SLC-mode) memory device die is skipped during generation of the second RAIN data and the third RAIN parity data, as the weak memory device die does not include UPs and XPs in SLC mode.

Likewise, where each weak memory device die is configured to operate in SLC mode and each non-weak memory device die is configured to operate in QLC mode, the processing device can generate first RAIN parity data by XORing non-parity data across LPs (of the select page stripe) of both weak (SLC-mode) and non-weak (QLC-mode) memory device die, can generate second RAIN parity data by XORing non-parity data stored across UPs (of the select page stripe) of non-weak (QLC-mode) memory device die, can generate third RAIN parity data by XORing non-parity data stored across XPs (of the select page stripe) of non-weak (QLC-mode) memory device die, and can generate fourth RAIN parity data by XORing non-parity data stored across TPs (of the select page stripe) of non-weak (QLC-mode) memory device die, where the first RAIN parity data, the second RAIN parity data, the third RAIN parity data, and the fourth RAIN parity data are combined (e.g., XOR'd) to generate the RAIN parity data for the select page stripe. In this way, the weak (SLC-mode) memory device die is skipped during generation of the second RAIN data and the third RAIN parity data, as the weak memory device die does not include UPs, XPs, and TPs in SLC mode.

The memory system of various example embodiments can be adapted to support different modes (e.g., larger bit-per-cell modes) or configurations of operations in a similar manner, where weak memory device die not including certain page types under their current operational mode/configuration are skipped from the portion of the RAIN parity generation that involves those certain page types.

At operation 212, the processing device stores the RAIN parity data in one or more pages of the select page stripe on a non-weak memory device die selected from the set of non-weak memory device die. For various example embodiments, the processing device ensures proper RAIN protection by logically reordering memory device die so that only a non-weak memory die is used to storing RAIN parity data. In particular, the processing device can determine (e.g., update or adjust) a logical order of the memory device die within the memory device such that a non-weak memory device, and not a weak memory device die, is designated as the memory device die used to store RAIN parity data. For example, where a RAIN protection (e.g., die-level or plane level RAIN protection) implemented by the memory system results in RAIN parity data being stored on one or more (e.g., all) memory device die planes of a last memory device die of the memory device, the processing device can determine the logical order of memory device die such that a non-weak memory device die is designated the last memory device die in the memory device.

During operation 214, the processing device generates P2L data for the select page stripe. Generation and storage of the RAIN parity data can be determined based on whether the memory device implements die-level RAIN protection or plane-level RAIN protection. At operation 216, the processing device stores the P2L data in a last page of the select page stripe based on the logical programming order. The last page can be determined based on the logical memory device die order of the plurality of memory device die, and the current operational mode or configuration of the last memory device die as determined based on the logical memory device die order. For instance, where the last page of the select page stripe is on a weak memory device die operating in SLC mode, the last page can be the last LP on (e.g., a last memory device die plane of) the weak memory device die. Where the last page of the select page stripe is on a non-weak memory device die operating in MLC mode, the last page can be the last UP on (e.g., a last memory device die plane of) the non-weak memory device die. Where the last page of the select page stripe is on a non-weak memory device die operating in TLC mode, the last page can be the last XP on (e.g., a last memory device die plane of) the non-weak memory device die. Where the last page of the select page stripe is on a non-weak memory device die operating in QLC mode, the last page can be the last TP on (e.g., a last memory device die plane of) the non-weak memory device die. Additionally, the last page of the select page stripe can be determined based on whether the memory device implements RAIN protection and, if implemented, what type of RAIN protection (e.g., die-level or plane-level RAIN protection).

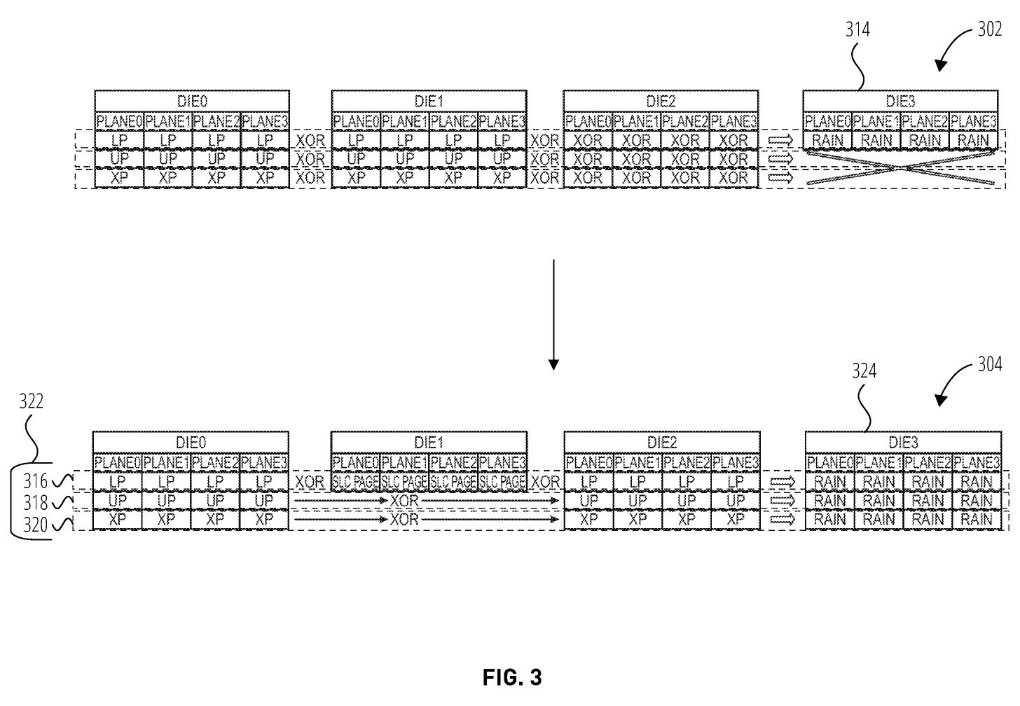

FIG. 3 is a diagram illustrating an example of how RAIN protection is handled with respect to memory device die having uneven PEC capability in a memory system, in accordance with some example embodiments of the present disclosure. In particular, FIG. 3 illustrates an example memory device die configuration 304 in accordance with various example embodiments, where each of memory device die 0, 2, and 3 (DIE 0, 2, 3) are configured to operate in TLC mode, where memory device die 1 (DIE 1) is configured to operate in SLC mode, and where a page stripe 322 is formed by LPs 316 across memory device die 0 through 3 (DIE 0, 1, 2, 3) (with the LPs on DIE 1 designated as SLC pages) and by UPs 318 and XPs 320 across memory device die 0, 2, and 3 (DIE 0, 2, 3).

In memory device die configuration 304, memory device die 3 (DIE 3) is designated as a RAIN memory device die 324 for storing die-level RAIN parity data. As shown, RAIN parity data stored on a LP on memory device die plane 0 of memory device die 3 is generated by XORing the LPs on memory device die plane 0 of each of memory device die 0, 1, and 2, RAIN parity data stored a LP on memory device die plane 1 of memory device die 3 is generated by XORing the LPs on memory device die plane 1 of each of memory device die 0, 1, and 2, RAIN parity data stored on a LP on memory device die plane 2 of memory device die 3 is generated by XORing the LPs on memory device die plane 2 of each of memory device die 0, 1, and 2, and RAIN parity data stored on a LP on memory device die plane 3 of memory device die 3 is generated by XORing the LPs on memory device die plane 3 of each of memory device die 0, 1, and 2.

However, RAIN parity data stored on UPs and XPs on memory device die 3 are generated differently. RAIN parity data stored on a UP on memory device die plane 0 of memory device die 3 is generated by XORing the UPs on memory device die plane 0 of each of memory device die 0 and 2 (memory device die 1 is skipped), RAIN parity data stored on a UP on memory device die plane 1 of memory device die 3 is generated by XORing the UPs on memory device die plane 1 of each of memory device die 0 and 2 (memory device die 0 is skipped), RAIN parity data stored on a UP on memory device die plane 2 of memory device die 3 is generated by XORing the UPs on memory device die plane 2 of each of memory device die 0 and 2 (memory device die 0 is skipped), and RAIN parity data stored on a UP on memory device die plane 3 of memory device die 3 is generated by XORing the UPs on memory device die plane 3 of each of memory device die 0 and 2 (memory device die 0 is skipped). Likewise, RAIN parity data stored on a XP on memory device die plane 0 of memory device die 3 is generated by XORing the XPs on memory device die plane 0 of each of memory device die 0 and 2 (memory device die 0 is skipped), RAIN parity data stored on a XP on memory device die plane 1 of memory device die 3 is generated by XORing the XPs on memory device die plane 1 of each of memory device die 0 and 2 (memory device die 0 is skipped), RAIN parity data stored on a XP on memory device die plane 2 of memory device die 3 is generated by XORing the XPs on memory device die plane 2 of each of memory device die 0 and 2 (memory device die 0 is skipped), and RAIN parity data stored on a XP on memory device die plane 3 of memory device die 3 is generated by XORing the XPs on memory device die plane 3 of each of memory device die 0 and 2 (memory device die 0 is skipped).

Though not shown, this approach can be adapted with respect to other operational modes or configurations for non-weak memory device die, such as MLC mode or QLC mode. Additionally, though not shown, a similar methodology can be used where plane-level (rather than die-level) RAIN protection is implemented on a memory device. For instance, RAIN parity data stored on a LP on memory device die plane 3 of memory device die 3 is generated by XORing all LPs on memory device die 0, all LPs on memory device die 1, all LPs on memory device die 2, and LPs on memory device die planes 0, 1 and 2 of memory device die 3. In comparison, RAIN parity data stored on a UP on memory device die plane 3 of memory device die 3 is generated by XORing all UPs on memory device die 0, all UPs on memory device die 2, and UPs on memory device die planes 0, 1 and 2 of memory device die 3 (memory device die 1 is skipped, as it does not have any UPs). Similarly, RAIN parity data stored on a XP on memory device die plane 3 of memory device die 3 is generated by XORing all XPs on memory device die 0, all XPs on memory device die 2, and XPs on memory device die planes 0, 1 and 2 of memory device die 3 (memory device die 1 is skipped, as it does not have any XPs).

As described herein, the memory system of various example embodiments determines (e.g., adjust or update) a logical order of memory device die to ensure that RAIN parity data is not stored on a weak memory device die. This can avoid a situation similar to example memory device die configuration 302, where die-level (and even plane-level) RAIN protection could not be implemented with a weak memory device die operating in SLC mode designated as a RAIN parity memory device die 314. Memory device die configuration 304 illustrates an example of how the processing device can determine a logical order of memory device die that avoids this issue.

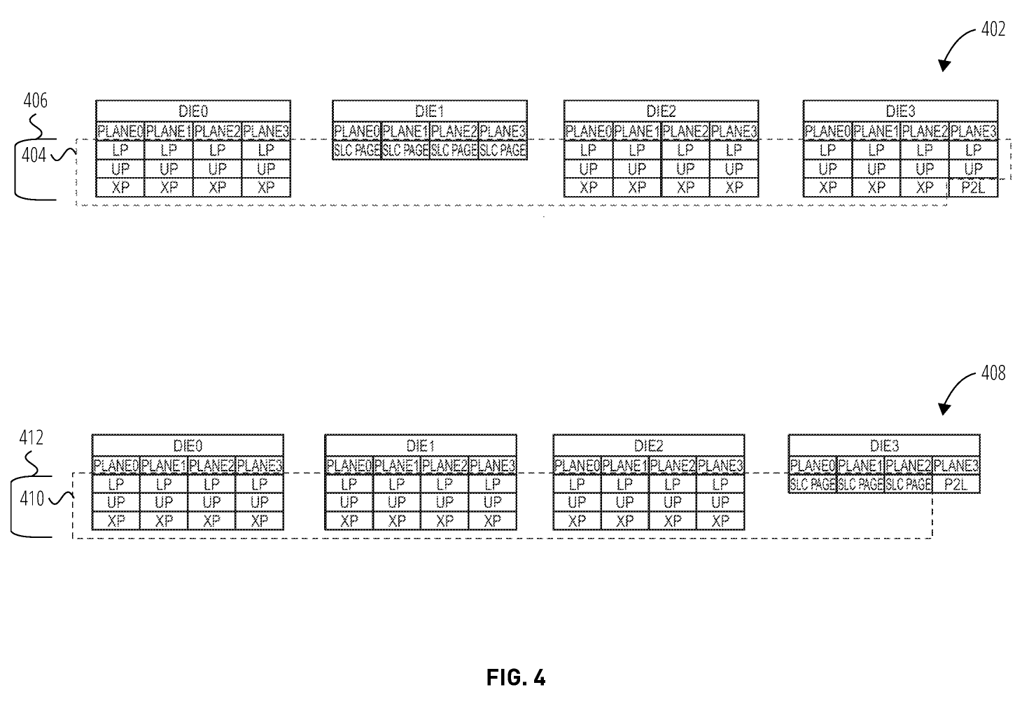

FIG. 4 is a diagram illustrating an example of how P2L data is handled with respect to memory device die having uneven PEC capability in a memory system, in accordance with some example embodiments of the present disclosure. In particular, FIG. 4 illustrates two example memory device die configurations 402, 408 in which P2L data is stored for a given page stripes 406, 412 respectively. With respect to memory device die configuration 402, the P2L data for pages 404 is stored in a XP on memory device die plane 3 of a non-weak memory device die 3 configured to operate in TLC mode. In comparison, with respect to memory device die configuration 408, the P2L data for pages 410 is stored in LP (e.g., SLC page) on memory device die plane 3 of a weak memory device die 3 configured to operate in SLC mode.

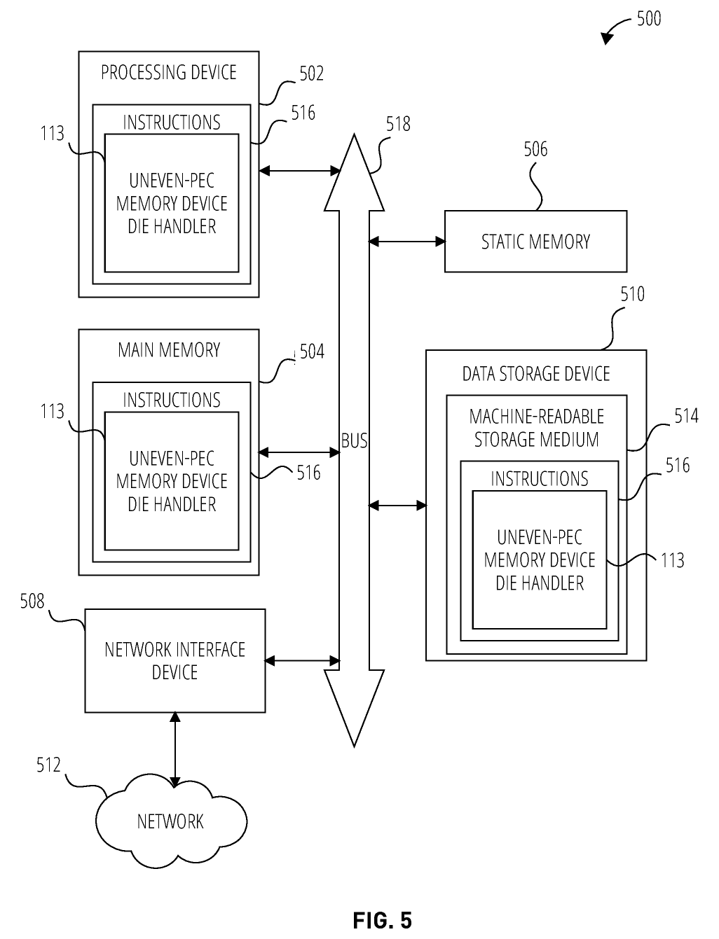

FIG. 5 illustrates an example machine in the form of a computer system 500 within which a set of instructions can be executed for causing the machine to perform any one or more of the methodologies discussed herein. In some example embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative example embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 510, which communicate with each other via a bus 518.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 516 for performing the operations and steps discussed herein. The computer system 500 can further include a network interface device 508 to communicate over a network 512.

The data storage device 510 can include a machine-readable storage medium 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage medium 514, data storage device 510, and/or main memory 504 can correspond to the memory sub-system 110 of FIG. 1.

In one example embodiment, the instructions 516 include instructions to implement functionality corresponding to handling memory device die with uneven PEC capability in a memory system as described herein (e.g., the uneven-PEC memory device die handler 113 of FIG. 1). While the machine-readable storage medium 514 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1 is a system comprising: a memory device comprising a plurality of memory device die; and a processing device operatively coupled to the memory device, the processing device performing operations comprising: determining a set of weak memory device die in the plurality of memory device die, each weak memory device die of the set of weak memory device die having a program/erase count (PEC) capability that is lower than a threshold PEC number; configuring an individual weak memory device die of the set of weak memory device die to operate in a first bit-per-cell mode that causes data to be stored at a first bit-per-cell density on the individual weak memory device die; configuring an individual non-weak memory device die of a set of non-weak memory device die of the plurality of memory device die to operate in a second bit-per-cell mode that causes data to be stored at a second bit-per-cell density on the individual non-weak memory device die, the first bit-per-cell density being lower than the second bit-per-cell density; and programming select data across a select page stripe at a select wordline of the plurality of memory device die, the programming of the select data across the select page stripe at the select wordline comprising: programming any pages of the select page stripe on any weak memory device die based on one or more page types associated with the first bit-per-cell mode; and programming any pages of the select page stripe on any non-weak memory device die based on one or more page types associated with the second bit-per-cell mode.

In Example 2, the subject matter of Example 1 includes, wherein each memory device die of the plurality of memory device die comprises a NAND-type memory device die.

In Example 3, the subject matter of Example 2 includes, wherein the memory device comprises a NAND-type memory package.

In Example 4, the subject matter of Examples 1–3 includes, wherein the first bit-per-cell mode comprises a single-level cell (SLC) mode.

In Example 5, the subject matter of Example 4 includes, wherein the one or more page types associated with the first bit-per-cell mode comprises a lower page (LP) at each wordline on each memory device die plane of a memory device die that is configured to operate in the first bit-per-cell mode.

In Example 6, the subject matter of Examples 1–5 includes, wherein the second bit-per-cell mode comprises a multi-level cell (MLC) mode.

In Example 7, the subject matter of Example 6 includes, wherein the one or more page types associated with the second bit-per-cell mode comprises a lower page (LP) and an upper page (UP) at each wordline on each memory device die plane of a memory device die that is configured to operate in the second bit-per-cell mode.

In Example 8, the subject matter of Examples 1–7 includes, wherein the second bit-per-cell mode comprises a triple-level cell (TLC) mode.

In Example 9, the subject matter of Example 8 includes, wherein the one or more page types associated with the second bit-per-cell mode comprises a lower page (LP), an upper page (UP), and an extra page (XP) at each wordline on each memory device die plane of a memory device die that is configured to operate in the second bit-per-cell mode.

In Example 10, the subject matter of Examples 1–9 includes, wherein the second bit-per-cell mode comprises a quad-level cell (QLC) mode.

In Example 11, the subject matter of Example 10 includes, wherein the one or more page types associated with the second bit-per-cell mode comprises a lower page (LP), an upper page (UP), an extra page (XP), and a top page (TP) at each wordline on each memory device die plane of a memory device die that is configured to operate in the second bit-per-cell mode.

In Example 12, the subject matter of Examples 1–11 includes, wherein the programming of any pages of the select page stripe on any non-weak memory device die based on one or more page types associated with the second bit-per-cell mode comprises: programming all pages of a first-page type on each memory device die plane of an individual non-weak memory device die prior to programming any page of a second-page type on each memory device die plane of the individual non-weak memory device die.

In Example 13, the subject matter of Examples 1–12 includes, wherein the programming of any pages of the select page stripe on any weak memory device die based on one or more page types associated with the first bit-per-cell mode comprises: programming all pages of a first-page type on each memory device die plane of an individual weak memory device die prior to programming any page of a second-page type on each memory device die plane of the individual weak memory device die.

In Example 14, the subject matter of Examples 1–13 includes, wherein the select data is programmed across the select page stripe at the select wordline of the plurality of memory device die according to a logical order assigned to the plurality of memory device die such that programming of pages of the select page stripe on a next memory device die does not start until all available pages of the select page stripe on a prior memory device die are programmed.

In Example 15, the subject matter of Examples 1–14 includes, wherein operations comprise: generating redundant array of independent NAND-type memory devices (RAIN) parity data for non-parity data stored in the select page stripe; and storing the RAIN parity data in one or more pages of the select page stripe on a non-weak memory device die selected from the set of non-weak memory device die.

In Example 16, the subject matter of Examples 1–15 includes, wherein the first bit-per-cell mode comprises a single-level cell (SLC) mode, wherein the second bit-per-cell mode comprises a multi-level cell (MLC) mode, and wherein operations comprise: generating redundant array of independent NAND-type memory devices (RAIN) parity data for non-parity data stored in the select page stripe, the generating of the RAIN parity data comprises: generating first RAIN parity data by exclusive OR-ing (XORing) non-parity data stored across lower pages (LPs) of the select page stripe on one or more non-weak memory device die of the plurality of memory device die and stored across LPs of the select page stripe on one or more weak memory device die of the plurality of memory device die; and generating second RAIN parity data by XORing non-parity data stored across upper pages (UPs) of the select page stripe on the one or more non-weak memory device die.

In Example 17, the subject matter of Examples 1–16 includes, wherein the first bit-per-cell mode comprises a single-level cell (SLC) mode, wherein the second bit-per-cell mode comprises a multi-level cell (TLC) mode, and wherein operations comprise: generating redundant array of independent NAND-type memory devices (RAIN) parity data for non-parity data stored in the select page stripe, the generating of the RAIN parity data comprises: generating first RAIN parity data by exclusive OR-ing (XORing) non-parity data stored across lower pages (LPs) of the select page stripe on one or more non-weak memory device die of the plurality of memory device die and stored across LPs of the select page stripe on one or more weak memory device die of the plurality of memory device die; generating second RAIN parity data by XORing non-parity data stored across upper pages (UPs) of the select page stripe on the one or more non-weak memory device die; and generating third RAIN parity data by XORing non-parity data stored across extra pages (XPs) of the select page stripe on the one or more non-weak memory device die.

In Example 18, the subject matter of Examples 1–17 includes, wherein the first bit-per-cell mode comprises a single-level cell (SLC) mode, wherein the second bit-per-cell mode comprises a multi-level cell (QLC) mode, and wherein operations comprise: generating redundant array of independent NAND-type memory devices (RAIN) parity data for non-parity data stored in the select page stripe, the generating of the RAIN parity data comprises: generating first RAIN parity data by exclusive OR-ing (XORing) non-parity data stored across lower pages (LPs) of the select page stripe on one or more non-weak memory device die of the plurality of memory device die and stored across LPs of the select page stripe on one or more weak memory device die of the plurality of memory device die; generating second RAIN parity data by XORing non-parity data stored across upper pages (UPs) of the select page stripe on the one or more non-weak memory device die; generating third RAIN parity data by XORing non-parity data stored across extra pages (XPs) of the select page stripe on the one or more non-weak memory device die; and generating fourth RAIN parity data by XORing non-parity data stored across top pages (TPs) of the select page stripe on the one or more non-weak memory device die.

In Example 19, the subject matter of Examples 1–18 includes, wherein pages of the select page stripe have a logical programming order, and wherein operations comprise: generating physical memory address-to-logical memory address (P2L) data for the select page stripe; and storing the P2L data in a last page of the select page stripe based on the logical programming order.

Example 20 is a method to implement any of Examples 1–19.

Example 21 is at least one machine-readable medium comprising instructions that, when executed by a processing device, cause the processing device to perform operations to implement any of Examples 1–19.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some example embodiments, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, example embodiments of the disclosure have been described with reference to specific example embodiments thereof. It will be evident that various modifications can be made thereto without departing from the broader spirit and scope of example embodiments of the disclosure as set forth in the following claims. The specification and drawings are, accordingly, to be regarded in an illustrative sense rather than a restrictive sense.

1. A system comprising:
a memory device comprising a plurality of memory device die; and
a processing device operatively coupled to the memory device, the processing device performing operations comprising:
determining a set of weak memory device die in the plurality of memory device die, each weak memory device die of the set of weak memory device die having a program/erase count (PEC) capability that is lower than a threshold PEC number;
configuring an individual weak memory device die of the set of weak memory device die to operate in a first bit-per-cell mode that causes data to be stored at a first bit-per-cell density on the individual weak memory device die;
configuring an individual non-weak memory device die of a set of non-weak memory device die of the plurality of memory device die to operate in a second bit-per-cell mode that causes data to be stored at a second bit-per-cell density on the individual non-weak memory device die, the first bit-per-cell density being lower than the second bit-per-cell density; and
programming select data across a select page stripe at a select wordline of the plurality of memory device die, the programming of the select data across the select page stripe at the select wordline comprising:
programming any pages of the select page stripe on any weak memory device die based on one or more page types associated with the first bit-per-cell mode; and
programming any pages of the select page stripe on any non-weak memory device die based on one or more page types associated with the second bit-per-cell mode.

2. The system of claim 1, wherein each memory device die of the plurality of memory device die comprises a NAND-type memory device die.

3. The system of claim 2, wherein the memory device comprises a NAND-type memory package.

4. The system of claim 1, wherein the first bit-per-cell mode comprises a single-level cell (SLC) mode.

5. The system of claim 4, wherein the one or more page types associated with the first bit-per-cell mode comprises a lower page (LP) at each wordline on each memory device die plane of a memory device die that is configured to operate in the first bit-per-cell mode.

6. The system of claim 1, wherein the second bit-per-cell mode comprises a multi-level cell (MLC) mode.

7. The system of claim 6, wherein the one or more page types associated with the second bit-per-cell mode comprises a lower page (LP) and an upper page (UP) at each wordline on each memory device die plane of a memory device die that is configured to operate in the second bit-per-cell mode.

8. The system of claim 1, wherein the second bit-per-cell mode comprises a triple-level cell (TLC) mode.

9. The system of claim 8, wherein the one or more page types associated with the second bit-per-cell mode comprises a lower page (LP), an upper page (UP), and an extra page (XP) at each wordline on each memory device die plane of a memory device die that is configured to operate in the second bit-per-cell mode.

10. The system of claim 1, wherein the second bit-per-cell mode comprises a quad-level cell (QLC) mode.

11. The system of claim 10, wherein the one or more page types associated with the second bit-per-cell mode comprises a lower page (LP), an upper page (UP), an extra page (XP), and a top page (TP) at each wordline on each memory device die plane of a memory device die that is configured to operate in the second bit-per-cell mode.

12. The system of claim 1, wherein the programming of any pages of the select page stripe on any non-weak memory device die based on one or more page types associated with the second bit-per-cell mode comprises:
programming all pages of a first-page type on each memory device die plane of an individual non-weak memory device die prior to programming any page of a second-page type on each memory device die plane of the individual non-weak memory device die.

13. The system of claim 1, wherein the programming of any pages of the select page stripe on any weak memory device die based on one or more page types associated with the first bit-per-cell mode comprises:
programming all pages of a first-page type on each memory device die plane of an individual weak memory device die prior to programming any page of a second-page type on each memory device die plane of the individual weak memory device die.

14. The system of claim 1, wherein the select data is programmed across the select page stripe at the select wordline of the plurality of memory device die according to a logical order assigned to the plurality of memory device die such that programming of pages of the select page stripe on a next memory device die does not start until all available pages of the select page stripe on a prior memory device die are programmed.

15. The system of claim 1, wherein operations comprise:
generating redundant array of independent NAND-type memory devices (RAIN) parity data for non-parity data stored in the select page stripe; and
storing the RAIN parity data in one or more pages of the select page stripe on a non-weak memory device die selected from the set of non-weak memory device die.

16. The system of claim 1, wherein the first bit-per-cell mode comprises a single-level cell (SLC) mode, wherein the second bit-per-cell mode comprises a multi-level cell (MLC) mode, and wherein operations comprise:
generating redundant array of independent NAND-type memory devices (RAIN) parity data for non-parity data stored in the select page stripe, the generating of the RAIN parity data comprises:
generating first RAIN parity data by exclusive OR-ing (XORing) non-parity data stored across lower pages (LPs) of the select page stripe on one or more non-weak memory device die of the plurality of memory device die and stored across LPs of the select page stripe on one or more weak memory device die of the plurality of memory device die; and
generating second RAIN parity data by XORing non-parity data stored across upper pages (UPs) of the select page stripe on the one or more non-weak memory device die.

17. The system of claim 1, wherein the first bit-per-cell mode comprises a single-level cell (SLC) mode, wherein the second bit-per-cell mode comprises a multi-level cell (TLC) mode, and wherein operations comprise:
generating redundant array of independent NAND-type memory devices (RAIN) parity data for non-parity data stored in the select page stripe, the generating of the RAIN parity data comprises:
generating first RAIN parity data by exclusive OR-ing (XORing) non-parity data stored across lower pages (LPs) of the select page stripe on one or more non-weak memory device die of the plurality of memory device die and stored across LPs of the select page stripe on one or more weak memory device die of the plurality of memory device die;
generating second RAIN parity data by XORing non-parity data stored across upper pages (UPs) of the select page stripe on the one or more non-weak memory device die; and
generating third RAIN parity data by XORing non-parity data stored across extra pages (XPs) of the select page stripe on the one or more non-weak memory device die.

18. The system of claim 1, wherein pages of the select page stripe have a logical programming order, and wherein operations comprise:
generating physical memory address-to-logical memory address (P2L) data for the select page stripe; and
storing the P2L data in a last page of the select page stripe based on the logical programming order.

19. At least one non-transitory machine-readable storage medium comprising instructions that, when executed by a processing device, cause the processing device to perform operations comprising:
determining a set of weak memory device die in a plurality of memory device die of a memory device, each weak memory device die of the set of weak memory device die having a program/erase count (PEC) capability that is lower than a threshold PEC number;
configuring an individual weak memory device die of the set of weak memory device die to operate in a first bit-per-cell mode that causes data to be stored at a first bit-per-cell density on the individual weak memory device die;
configuring an individual non-weak memory device die of a set of non-weak memory device die of the plurality of memory device die to operate in a second bit-per-cell mode that causes data to be stored at a second bit-per-cell density on the individual non-weak memory device die, the first bit-per-cell density being lower than the second bit-per-cell density; and
programming select data across a select page stripe at a select wordline of the plurality of memory device die, the programming of the select data across the select page stripe at the select wordline comprising:
programming any pages of the select page stripe on any weak memory device die based on one or more page types associated with the first bit-per-cell mode; and
programming any pages of the select page stripe on any non-weak memory device die based on one or more page types associated with the second bit-per-cell mode.

20. A method comprising:
determining, by a processing device of a memory system controller, a set of weak memory device die in a plurality of memory device die of a memory device of a memory system, each weak memory device die of the set of weak memory device die having a program/erase count (PEC) capability that is lower than a threshold PEC number;
configuring, by the processing device, an individual weak memory device die of the set of weak memory device die to operate in a first bit-per-cell mode that causes data to be stored at a first bit-per-cell density on the individual weak memory device die;
configuring, by the processing device, an individual non-weak memory device die of a set of non-weak memory device die of the plurality of memory device die to operate in a second bit-per-cell mode that causes data to be stored at a second bit-per-cell density on the individual non-weak memory device die, the first bit-per-cell density being lower than the second bit-per-cell density; and
programming, by the processing device, select data across a select page stripe at a select wordline of the plurality of memory device die, the programming of the select data across the select page stripe at the select wordline comprising:
programming any pages of the select page stripe on any weak memory device die based on one or more page types associated with the first bit-per-cell mode; and
programming any pages of the select page stripe on any non-weak memory device die based on one or more page types associated with the second bit-per-cell mode.
